(19) United States
(12) Patent Application Publication
(10) Pub. No.: US 2026/0148045 A1
(43) Pub. Date: May 28, 2026

(54) EFFICIENT GENERATIVE MODEL ROUTING USING AN EARLY EXIT HEAD

(71) Applicant: GOOGLE LLC, Mountain View, CA (US)

(72) Inventors: Chen-Yu Lee, Cupertino, CA (US); Salem Elie Haykal, Seattle, WA (US); Zifeng Wang, Los Angeles, CA (US); Parashar Shah, Newcastle, WA (US); Anqi Mao, Jersey City, NJ (US); Harikrishna Narasimhan, Sunnyvale, CA (US); Mehryar Mohri, New York, NY (US); Wittawat Jitkrittum, Jersey City, NJ (US); Fanglin Lu, Palo Alto, CA (US); Wenjie Yuan, Cupertino, CA (US); Apurv Suman, New York, NY (US); Aditya Krishna Menon, New York, NY (US); Javier Gonzalvo, New York, NY (US); Seungyeon Kim, New York, NY (US); Yutao Zhong, Jersey City, NJ (US); Paramjit Singh Sandhu, Sunnyvale, CA (US); Anand R. Iyer, Sunnyvale, CA (US); Venkatraman Subramanian, Bangalore (IN)

(21) Appl. No.: 18/962,696

(22) Filed: Nov. 27, 2024

(51) Int. Cl. G06N 3/0475

(52) U.S. Cl. CPC G06N 3/0475

(57) ABSTRACT

Efficiently routing requests among multiple generative models with varying computational costs. A request is initially processed by an initial generative model, which can optionally be the most computationally efficient of the generative models. During processing of the request using the initial generative model, but prior to completing processing of the request utilizing the initial generative model and prior to initiating processing of the request utilizing any additional generative model of the generative models, intermediate output, from an intermediate layer of the initial generative model, is processed using an early exit (EE) head to generate EE output. A routing decision is made based on the EE output. The routing decision includes determining whether to continue utilizing the initial generative model or to instead initiating processing of the request utilizing an alternative generative model of the set of generative models.

### BACKGROUND

Many generative models can be of a very large size, often including billions of parameters (e.g., over 100 billion parameters, over 250 billion parameters, or over 500 billion parameters). Due to the large size of such a generative model, significant memory, processor, power, and/or other computational resource(s) can be required to process an input, using the generative model, to generate a corresponding generative output. This resource utilization can be significant on a per input basis, and very significant when hundreds or thousands of inputs are being processed per minute, per second, or other interval. Also, due to the large size of such a generative model, there can be significant latency in generating a corresponding generative output and, as a result, in rendering corresponding generative content. Such latency can lead to prolonging user-to-computer interaction.

Smaller size counterparts to such generative models do exist, such as a separately trained counterpart with less parameters or a pruned and/or quantized counterpart generated from applying one or more pruning techniques and/or one or more quantization techniques to the larger counterpart. For example, a smaller counterpart to a larger model can include 25%, 33%, 50%, 66% or other percentage less parameters than the larger model. However, such smaller size counterparts can be less robust and/or less accurate than their larger size counterpart. Accordingly, while utilizing such a smaller size counterpart to process an input can be more computationally efficient and/or can be performed with less latency, there is a greater risk that corresponding generative output, generated by processing the input, can be inaccurate and/or under-specified.

More generally, multiple generative models can be available for processing an input and each of the generative models can have differing attributes (e.g., differing computational efficiencies, differing weights due to differing training or fine-tuning, etc.). It is desirable to select a generative model, from among the multiple generative models, that is likely to generate responsive generative output that resolves the input (e.g., to prevent the need for further input(s) to reach a resolution) and that is also the most computationally efficient generative model for generating generative output that resolves the input (e.g., to conserve computational resources from needlessly utilizing a less computationally efficient generative model).

Various techniques have been proposed for selecting a generative model, from among multiple generative models, for utilization in responding to a request. For example, some techniques utilize an initial routing machine learning model, that is separate from the multiple generative models, and that can be used to process features of a request to generate output that reflects which of the multiple generative models is most appropriate for utilization in processing the input. A generative model can be selected based on such output, and the request can then be routed to the selected generative model for processing. However, such techniques can have various drawbacks. For example, with such techniques it is necessary to maintain and execute a separate initial routing machine learning model that utilizes processor and memory resources. As another example, with such techniques it is necessary to first process features of an input, using the initial routing machine learning model, prior to any processing of the input by a selected generative model. This introduces latency in responding to the input. Namely, it introduces an amount of latency that corresponds to an amount of time needed for processing of the features of the input using the initial routine machine learning model.

### SUMMARY

Implementations disclosed herein are directed to selecting, in response to receiving a request and from among multiple candidate generative models with differing computational efficiencies, a particular generative model to utilize in generating a response to the request. Implementations dismiss with the need to utilize a separate initial routing machine learning model that utilizes processor and memory resources. Rather, various implementations begin processing a request utilizing an initial generative model and proceed, in a forward pass during such processing, to processing using an intermediate layer (i.e., not an initial layer and not a terminal layer) of the generative model. Intermediate layer output, generated from the processing using the intermediate layer, is processed using an early exit (EE) head to generate EE output that reflects whether the forward pass should continue utilizing the initial generative model or, instead, the request should be processed utilizing an alternative generative model. The intermediate layer can be, for example, a decoder layer in a decoder of the initial generative model, such as an attention-based decoder layer (e.g., self-attention layer) of the initial generative model. The initial generative model can be, for example, an encoder-decoder model or a decoder-only model.

If the EE output reflects that the forward pass should continue utilizing the initial generative model, the forward pass is continued utilizing the initial generative model and a response, generated based on output from the initial generative model based on the continued forward pass, is provided in response to the request—and is provided without any utilization of any alternative generative model. In these and other manners, when the EE output reflects that the forward pass should continue utilizing the initial generative model, the response is provided quickly (e.g., as a result of the forward pass having already proceeded to the intermediate layer) and without any latency introduced by having a separate initial routing machine learning model.

If, on the other hand, the EE output reflects that the request should be processed utilizing an alternative generative model, processing of the request utilizing the alternative generative model is initiated and a response, generated based on output from the alternative generative model based on processing the request, is provided in response to the request. This alternative scenario does require processing of the request during a forward pass to the intermediate layer of the initial generative model, followed by full processing of the request utilizing the alternative generative model. However, latency introduced by the forward pass to the intermediate layer of the initial generative model can be similar to or lesser than latency introduced by having a separate initial routing machine learning model. Further, some percentage of requests will result in full processing utilizing the initial generative model and without any utilization of any alternative generative model—thereby achieving lesser latency for at least those requests. Yet further, in various implementations the initial generative model is more computationally efficient than one or more (e.g., all) alternative generative model(s), ensuring a greater degree of computational efficiency in situations in which full processing is performed utilizing the initial generative model.

The EE head can include one or more layers, such as one or more feed-forward layers. The EE head can be utilized to generate EE output that reflects at least a continuance measure that reflects whether processing utilizing the initial generative model should continue. For example, a single alternative generative model can be provided and, when the continuance measure satisfies a threshold, processing utilizing the initial generative model can be continued (without any processing using the single alternative generative model) and, otherwise, processing using the single alternative generative model can be initiated. As another example, multiple alternative generative models can be provided and the EE head can be utilized to generate EE output that reflects the continuance measure and, for each of the multiple alternative generative models, a corresponding measure that reflects whether the alternative generative model should be utilized. The continuance measure and, optionally, the corresponding measure(s) can be utilized in determining whether to continue the forward pass utilizing the initial generative model or to instead utilize one of the alternative generative models. For example, if the continuance measure satisfies a threshold, processing utilizing the initial generative model can be continued and, otherwise, processing using one of the alternative generative models can be initiated. For instance, processing can be initiated using the most efficient of the alternative generative model(s) that have a corresponding measure satisfying a threshold.

In various implementations the EE head can be fine-tuned for routing decisions. For example, the EE head can be fine-tuned utilizing, for example, supervised and/or semi-supervised training data. In some implementations, the EE head is trained, at least initially, in conjunction with training of the initial generative model. For example, losses generated during training of the initial generative model can be utilized in updating the EE head. For instance, if the EE head is utilized to generate a continuance measure that reflects whether processing utilizing the initial generative model should continue, the loss applied to the EE head can be proportional to, or even the same as, the loss generated during training of the initial generative model. In various implementations, after training of the initial generative model, the weights of the initial generative model are frozen and then the EE head is then fine-tuned for routing decisions.

As a particular example, assume that the EE head is utilized to generate output that characterizes a continuance measure that reflects a value of continuing utilizing the generative model rather than initiating processing using an alternative generative model. During training of the initial generative model, the EE head can be updated based on losses that are generated for the initial generative model.

For example, a loss for the initial generative model can be generated based on comparing predicted output, from full processing of training instance input using the initial generative model, to a ground truth generative output of the corresponding training instance. For instance, the loss can be based on how closely the predicted output matches the ground truth generative output. The loss can be backpropagated to update the initial generative model and the loss, or a separate loss (generated based on the loss or component(s) of the loss) also backpropagated to update the EE head. For example, a separate loss can be generated based on comparing EE output, generated based on processing intermediate layer output (generated during processing of the training instance input) using the EE head, to a probability measure, in the predicted output, for the ground truth generative output. Such a separate loss can be used to train the EE head to generate EE output to approximate the probability that would be reflected, in predicted output of the initial generative model, for correct output-but to do so based on processing intermediate output. Put another way, such a separate loss can train the EE head for generating a continuance measure that approximates a probability of the initial generative model generating correct output. Such a separate loss can be used to update the EE head.

As another example, a loss can be generated based on processing output, from full processing of training instance input using the initial generative model, utilizing a reward model (e.g., one trained using human (RLHF) and/or machine feedback (RLMF)). The loss can be backpropagated to update the initial generative model and the loss, or a separate loss (generated based on the loss or components of the loss) backpropagated to update the EE head. For instance, if the loss for the initial generative model is minimal, it indicates that the output of the initial generative model matches the ground truth label of the training instance-which indicates that the EE head should also have generated EE output that reflects a high value for the continuance measure. Put another way, if the loss for the initial generative model is minimal, it indicates that the EE head should generate a continuance measure that indicates to continue decoding utilizing the initial generative model. Alternatively, if the loss for the initial generative model is significant, it indicates that the output of the EE head should generate a continuance measure that indicates to initiate decoding utilizing an alternative generative model. This can train the EE head to generate EE output to approximate the reward that would be generated by a reward model—but to do so based on processing intermediate output as opposed to final predicted output.

In some implementations, the EE head is fine-tuned. In some of those implementations, the EE head is fine-tuned based on training instances that include (a) training instance input that includes a request, and (b) ground truth value labels for the initial generative model and, optionally, for each of one or more corresponding alternative generative models. For example, the EE head can be fine-tuned after training of the initial generative model and after freezing the weights of the initial generative model. In some of those implementations, the ground truth value labels for the training instance are generated by, for each of the generative models (including the initial generative model and alternative generative model(s)):
processing the request (corresponding to the request features of the training instance input), using the corresponding generative model, to generate corresponding output; and generating a corresponding measure, for the corresponding generative model, by comparing the corresponding output to the ground truth response. For example, the value for the initial generative model can be based on first score(s) that are each generated based on comparing the ground truth response to first generative model output, for the initial generative model, generated based on processing the request using the initial generative model. Likewise, the value for an alternative generative model can be based on second score(s) that are each generated based on comparing the ground truth response to second generative model output, for the second generative model, generated based on processing the request using the second generative model. The score(s) generated based on comparing the ground truth response to given generative model output can be generated based on how closely the given generative model output conforms to the ground truth response. For instance, the score(s) can include a negative log-likelihood score and/or a perplexity score. Those and/or other score(s) can optionally be generated based on comparing the ground truth response to a given sequence of probability distributions over a vocabulary that is reflected in the given generative model output (e.g., generated as a function of the probabilities for the ground truth response in the probability distributions). As another example, a reward model can be used to process the generative model outputs, of the generative models, and the reward scores that are generated based on such processing can be used as the scores.

As a non-limiting working example, assume that the initial generative model is a first LLM that includes 50 billion parameters and that the alternative generative models include a second LLM that includes 100 billion parameters and a third LLM that includes 500 billion parameters. In some implementations, the first LLM can be a quantized and/or pruned version of the second or third LLM. In some other implementations, the first LLM is not a quantized and/or pruned version of the second or third LLM but, instead, is wholly independent of the second and third LLM. For example, the first LLM can have a different architecture relative to the second and third LLM and/or can be trained on a unique set of training data relative to the second and third LLM.

Continuing with the working example, the first LLM can be more computationally efficient than the second LLM and the second LLM can be more computationally efficient than the third LLM. For example, processing a request utilizing the first LLM can occur with less latency than processing the request utilizing the second LLM and/or processing the request utilizing the first LLM can utilize less memory, processor, and/or power resource(s) than processing the request utilizing the second LLM. For many requests, utilizing the first LLM or the second LLM or the third LLM to process the request and generate corresponding LLM output results in a similar (or even the same) response being generated. Accordingly, for such requests, utilizing the first LLM in lieu of the second or third LLM would result in a response being generated that is semantically similar (or even the same) to one that would have been generated had the second or third LLM instead been utilized. Such a response can be rendered in response to the request and will satisfy the informational needs of the request. However, for other requests, utilizing the first LLM to process the request and generate output results in a response being generated that is inaccurate and/or under-specified. On the other hand, processing many of such requests utilizing the second or third LLM to generate output results in an alternate response being generated that is accurate and that is not under-specified. Accordingly, for such requests, utilizing the second or third LLM model is desirable. Further, utilizing the second or third LLM model for such requests can result in computational efficiencies for the user-to-computer interactions, associated with those requests, as a whole. For example, utilizing the second or third LLM model for such requests mitigates occurrences of computational and/or network inefficiencies that result from a corresponding user issuing a follow-up request to cure the inaccuracies and/or under-specification of a generated response and/or from a user performing further action(s) based on an inaccurate and/or under-specified response.

Continuing with the example, a request can be received and processed utilizing the first LLM, which is the initial generative model, and proceed, in a forward pass during such processing, to processing using an intermediate layer of the first LLM. Intermediate layer output, generated from the processing using the intermediate layer, is processed using an early exit (EE) head of the first LLM to generate EE output that reflects whether the forward pass and decoding should continue utilizing the initial generative model or, instead, the request should be processed utilizing one of the second and third LLMs.

For example, the EE output can include a continuance measure that characterizes a value for continuing utilizing the first LLM, can include a second measure that characterizes a value for instead utilizing the second LLM, and can include a third measure that characterizes a value for instead utilizing the third LLM.

If the continuance measure satisfies one or more thresholds (e.g., absolute and/or relative to other measure(s)), then the forward pass continues utilizing the first LLM and a response, generated based on output from the first LLM based on the continued forward pass, is provided in response to the request—and is provided without any utilization of the second or third LLMs. For example, if the continuance measure satisfies an absolute threshold, such as a fixed absolute threshold or a dynamic absolute threshold that is based on current server load(s) and/or other dynamic conditions, then the forward pass can continue utilizing the first LLM and a resulting response provided without any utilization of the second or third LLMs.

If instead the second measure satisfies one or more thresholds (e.g., absolute and/or relative to other measure(s)), processing of the request utilizing the second LLM is initiated and a response, generated based on output from the second LLM based on processing the request, is provided in response to the request.

If instead the third measure satisfies one or more thresholds (e.g., absolute and/or relative to other measure(s)), processing of the request utilizing the third LLM is initiated and a response, generated based on output from the third LLM based on processing the request, is provided in response to the request.

Some implementations can include a system that includes one or more processors and memory storing instructions that, when executed by the one or more processors (e.g., central processing unit(s), tensor processing unit(s) TPU(s), graphics processing unit(s) GPU(s), and/or other processors), cause the one or more processors to perform a method such as one of those described herein. Some implementations can additionally or alternatively include one or more non-transitory computer readable storage media storing computer instructions executable by one or more processors to perform a method such as one of those described herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2A depicts an example of how components of FIG. 1 can interact in beginning to process a request utilizing an initial generative model and determining to continue, based on output from an early exit (EE) head of the initial generative model, to continue utilizing the initial generative model.

FIG. 2B depicts an example of how components of FIG. 1 can interact in beginning to process a request utilizing an initial generative model and determining, during the processing but prior to completion of the processing, to initiate processing of the request utilizing an alternative generative model.

FIG. 3A depicts another example of how components of FIG. 1 can interact in beginning to process a request utilizing an initial generative model and determining to continue, based on output from an early exit (EE) head of the initial generative model, to continue utilizing the initial generative model.

FIG. 3B depicts another example of how components of FIG. 1 can interact in beginning to process a request utilizing an initial generative model and determining, during the processing but prior to completion of the processing, to initiate processing of the request utilizing an alternative generative model.

FIG. 4 is a flowchart that illustrates an example method of, in response to receiving a request, beginning processing of the request using an initial generative model and, prior to completion of decoding of the request that is based on the initial generative model, determining whether to route the request to an alternative generative model for generating a response to the request or to instead continue using the initial generative model in generating a response to the request.

FIG. 5 is a flowchart that illustrates an example method of training an early exit (EE) head.

FIG. 6 illustrates an example architecture of a computing device.

### DETAILED DESCRIPTION

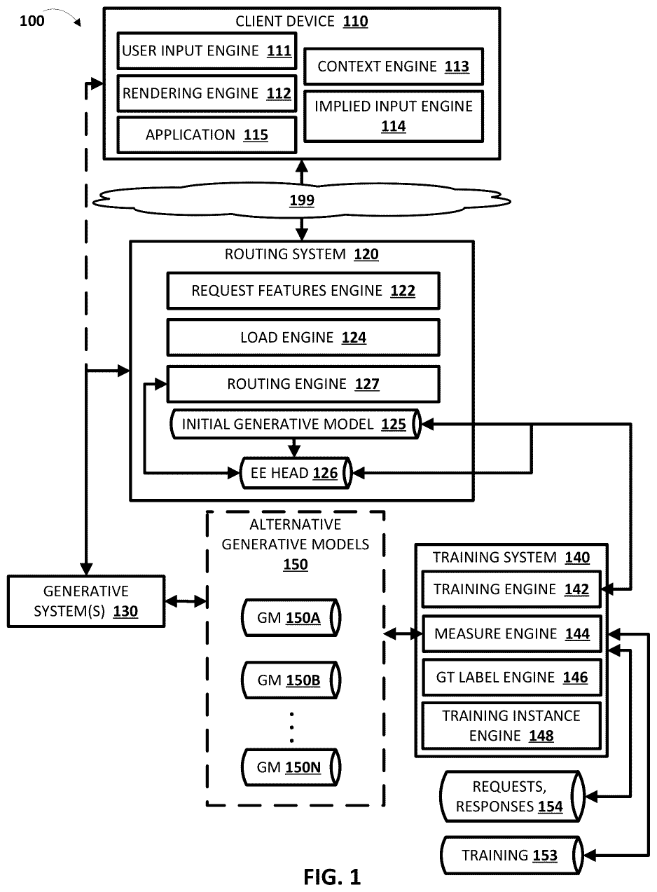

Turning now to FIG. 1, a block diagram of an example environment 100 that demonstrates various aspects of the present disclosure, and in which implementations disclosed herein can be implemented is depicted. The example environment 100 includes a client device 110, a routing system 120, generative system(s) 130, and a training system 140. The example environment 100 further includes ML model(s) 152 that can optionally be used by the routing system 120, candidate generative models 150 that are utilized by the generative system(s) 130, and requests, responses database 154 that can optionally be used by the training system 140 in training the ML model(s) 152.

FIG. 1 depicts a block diagram of an example environment 100 that demonstrates various aspects of the present disclosure, and in which implementations disclosed herein can be implemented. The example environment 100 includes a client device 110, a routing system 120, generative system(s) 130, and a training system 140. The example environment 100 also includes alternative generative models 150 that are selectively utilized by the generative system(s) 130 in generating generative responses. The routing system 120 also includes an initial generative model 125, that includes an EE head 126, and that is at least selectively utilized by the generative system(s) 130 in generating generative responses. The routing system 120 further includes a routing engine 127 that utilizes output, generated utilizing the EE head 126 during initial processing of a received request utilizing the initial generative model, for determining whether to continue processing of a received request utilizing the initial generative model 125 or to instead route the request to one of the alternative generative models 150. The training system 140 is used in training the EE head 126. The training system 140 can optionally interact with a training database 153 that can optionally be used by the training system 140 in training the EE head 126 in conjunction with training initial generative model 125. The training system 140 can additionally or alternative interact with a requests, responses database 154 that can be used by the training system 140 in supervised training of the EE head 126.

The initial generative model 125, of the routing system 120, is a generative model such as an LLM, and the alternative generative models 150 of FIG. 1 include generative model 150A, generative model 150B, and generative model 150N. In some implementations, only one or only two alternative generative models are included among the alternative generative models 150. In other implementations, more than three alternative generative models can be included among the alternative generative models 150, as indicated by the vertical ellipsis in FIG. 1. Each of the generative models, including the initial generative model 125 and the alternative generative models 150, can have differing computational efficiencies relative to one another. As a non-limiting example, initial generative model 125 can have less than 25 billion parameters, generative model 150A can have between 25 billion and 100 billion parameters, generative model 150B can have between 100 billion and 250 billion parameters, and generative model 150N can have over 250 billion parameters.

Although illustrated separately, in some implementations all or aspects of routing system 120 and generative system(s) 130 can be implemented as part of a cohesive system. For example, the same entity can be in control of both the routing system 120 and generative system(s) 130, and implement them cohesively. However, in some implementations the routing system 120 and one or more of the generative system(s) 130 can be controlled by separate parties. In some of those implementations, the routing system 120 can interface with such generative system(s) 130 utilizing, for example, application programming interface(s) (APIs) of such generative system(s) 130. For example, the routing system 120 can transmit, using an API of a generative system, a request and an indication of which alternative generative model is to be utilized in processing the request.

In some implementations, all or aspects of the routing system 120 can be implemented locally at the client device 110. For example, the initial generative model 125 can be stored locally at the client device 110 and processor(s) of the client device 110 utilized in generating EE output and generative output utilizing the initial generative model 125. In additional or alternative implementations, all or aspects of the routing system 120 can be implemented remotely from the client device 110 as depicted in FIG. 1 (e.g., at remote server(s)). In those implementations, the client device 110 and the routing system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more applications, such as application 115, via which queries, that are included in requests, can be submitted and/or via which generative response(s) generated by generative model(s) (e.g., LLM(s)) and/or other response(s) to the requests can be rendered (e.g., audibly and/or visually). The application 115 can be an application that is separate from an operating system of the client device 110 (e.g., one installed “on top” of the operating system) - or can alternatively be implemented directly by the operating system of the client device 110. For example, the application 115 can be a web browser installed on top of the operating system, or can be an application that is integrated as part of the operating system functionality. The application 115 can interact with the routing system 120 and/or the generative system(s) 130.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of a query described herein, that can be included in a request, can be a query that is formulated based on user input provided by a user of the client device 110 and detected via user input engine 111. For example, the query can be a typed query that is typed via a physical or virtual keyboard, a suggested query that is selected via a touch screen or a mouse, a spoken voice query that is detected via microphone(s) of the client device, an image query that is based on an image captured by a vision component of the client device, and/or a multimodal query such as one that includes an image and a typed query or one that includes audio data that captures a spoken voice query and that includes a predicted transcription of the spoken voice query.

In various implementations, the client device 110 can include a rendering engine 112 that is configured to provide a generative response (e.g., a natural language based response generated by an LLM) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In some of those implementations, the context engine 113 can determine a context utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a current state of a query session (e.g., considering one or more recent queries of the query session), profile data, and/or a current location of the client device 110. For instance, the context engine 113 can determine a current context of “looking for a healthy lunch restaurant in Louisville, Kentucky” based on a recently issued query, profile data, and a location of the client device 110. As another example, the context engine 113 can determine a current context based on which application is active in the foreground of the client device 110, a current or recent state of the active application, and/or content currently or recently rendered by the active application. A context determined by the context engine 113 can be utilized, for example, as all or part of dialog context described herein. A context determined by the context engine 113 can additionally or alternatively be utilized, for example, in supplementing or rewriting a query that is formulated based on user input, in generating an implied query (e.g., a query formulated independent of user input), and/or in determining to submit an implied query and/or to render result(s) (e.g., an LLM generated response) for an implied query.

In various implementations, the client device 110 can include an implied input engine 114 that is configured to: generate an implied query independent of any user input directed to formulating the implied query; to submit a request that includes the implied query, optionally independent of any user input that requests submission of the request; and/or to cause rendering of a response for an implied query, optionally independent of any user input that requests rendering of the response. For example, the implied input engine 114 can use current context, such as current location and/or current query, from current context engine 113, in generating an implied query, determining to submit a request that includes the implied query, and/or in determining to cause rendering of a response for the implied query. For instance, the implied input engine 114 can automatically generate and automatically submit an implied query based on the current context. Further, the implied input engine 114 can automatically push a response to the implied query to cause the response to be automatically rendered or can automatically push a notification of the response, such as a selectable notification that, when selected, causes rendering of the response. As another example, the implied input engine 114 can generate an implied query based on profile data (e.g., an implied query related to an interest of a user), submit the query at regular or non-regular intervals, and cause a corresponding response to be automatically provided (or a notification thereof automatically provided).

Further, the client device 110, the routing system 120, the generative system(s) 130, and/or the training system 140 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device 110 having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

Routing system 120 is illustrated as including a request features engine 122, a load engine 124, an initial generative model 125, an EE head 126, and a routing decision engine 127. Some of the engines can be omitted in various implementations.

The request features engine 122 can, in response to receiving a request, from client device 110 or other client device, generate request feature(s) for the request. The request feature(s) can include query feature(s) of a query included in the request, such as query features that are based on term(s) of a natural language query included in the request. The request features can additionally or alternatively include dialog context features that are based on prior request(s) and/or prior response(s) of an ongoing dialog in which the request is provided. One or more of the dialog context features, the prior response(s), and/or the prior request(s) can be included as part of the request (e.g., generated by the context engine 113). Additionally or alternatively, one or more of the dialog context features, the prior response(s), and/or the prior request(s) may not be included as part of the request, but the request features engine 122 can retrieve them (e.g., from remote storage accessible by the routing system 120) using the request (e.g., using an attribute identifier of the request). The request features can additionally or alternatively include attribute feature(s) associated with a client device and/or user that initiated the request. For example, the request can include an attribute identifier and the request features engine 122 can generate attribute feature(s) using the attribute identifier.

The load engine 124 optionally determines a current server load, which can be a measured or expected/predicted server load. The current server load characterizes a magnitude of computational resource utilization being experienced by one or more (e.g., all) of the generative system(s) 130. The load engine 124 can utilize one or more techniques in determining the current server load. For example, the load engine 124 can communicate with the generative system(s) 130 and obtain, from the generative system(s) 130, the current server load directly or current metric(s) that can be utilized by the load engine to determine the current server load. As another example, the load engine 124 can predict the current server load based on a quantity of recent requests processed by the routing system 120 and, optionally, the selections made by the routing system 120 for those recent requests. For instance, the load engine 124 can predict a higher current server load if 1,000 requests were processed by the routing system 120 in the last second as compared to if only 500 requests were processed by the routing system 120 in the last second. Also, for instance, the load engine 124 can predict a higher current server load if 1,000 requests were processed by the routing system 120 in the last second and 33% were selected for handling by the least computationally efficient of the candidate generative models 150 as compared to if 1,000 requests were processed by the routing system 120 in the last second and only 5% were selected for handling by the least computationally efficient of the candidate generative models 150.

In response to receiving a request from client device 110 or other device, the request can begin to be processed by the initial generative model 125. As the request is being processed by the initial generative model 125, the EE head 126 generates EE output based on processing of intermediate layer output generated using an intermediate layer of the initial generative model 125. Notably, the intermediate layer output is generated prior to completion of decoding of the request based on the initial generative model 125 processing the request and, further, the routing engine 127 determines a routing decision that is based on the EE output prior to completion of decoding. The routing engine 127 utilizes the EE output to determine whether to continue utilizing the initial generative model 125 to process the request or instead to cause the request to be processed by one of the alternative generative models 150.

For example, the routing engine 127 can utilize output, generated utilizing the EE head 126, for determining whether to continue processing of a received request utilizing the initial generative model 125 or whether to route the request to an alternative generative model. For example, the routing engine 127 can determine whether to continue processing utilizing the initial generative model 125 or whether to route the request to an alternative generative model based on a continuance measure that is reflected in EE output generated utilizing the EE head 126. For instance, if the continuance measure is below a threshold, the routing engine 127 can determine to route the request to an alternative generative model. Alternatively, if the continuance measure is above a threshold, the routing engine 127 can determine to continue processing utilizing the initial generative model 125. As another example, assume the EE output includes three or more measures that includes a continuance measure, a second measure that reflects a value for instead utilizing candidate generative model 150A, and a third measure that reflects a value for instead utilizing candidate generative model 150B. Further assume that the continuance measure fails to satisfy a threshold, the second measure satisfies the threshold, and the third measure also satisfies the threshold. In such a scenario, the routing engine 127 can route the request to utilize alternative generative model 150A. It is noted that the routing engine 127 can determine to route the request to alternative generative model 150A based at least in part on the alternative generative model 150A being more computationally efficient than is the alternative generative model 150B. For example, the routing engine 127 can select, from among multiple alternative generative models, the alternative generative model that, among those having a corresponding measure satisfying a threshold, is most computationally efficient.

The initial generative model 125 can be, for example, an LLM that includes less than 100 billion parameters. In some implementations, the initial generative model 125 can be a quantized and/or pruned version of one or more of the alternative generative models 150. In other implementations, the initial generative model 125 can be a generative model that is not a quantized and/or pruned version of one or more of the alternative generative models 150. For example, the initial generative model 125 can be a generative model that has a different architecture relative to one or more of the alternative generative models 150 and/or that is trained on a unique set of training data relative to one or more of the alternative generative models 150.

The EE head 126 can include one or more layers, such as one or more feed-forward layers. The EE head 126 can be fine-tuned for routing decisions utilizing, for example, supervised training data. In some implementations, the EE head 126 is trained in conjunction with the initial generative model 125 (e.g., losses generated during training of the initial generative model 125 are utilized in updating the EE head 126). In some of those implementations, after training of the initial generative model 125, the weights of the initial generative model 125 are frozen and then the EE head 126 is fine-tuned for routing decisions. In various implementations, the EE head 126 includes 1%, 2%, 5%, 10% or other percentage less parameters than the remainder of the initial generative model 125 and/or than any other of the alternative generative models 150. More generally, the computational resources saved through selections made, using the EE head 126, will be greater than the computational resources utilized in utilizing the EE head 126 in making those selections.

In some implementations, the EE head 126 is fine-tuned based on training instances that include (a) training instance input that includes a request, and (b) ground truth value labels for the initial generative model 125 and for each of one or more corresponding alternative generative models. In some of those implementations, the ground truth value labels for the training instance are generated by, for each of the generative models: processing the request (corresponding to the request features of the training instance input), using the generative model, to generate corresponding output; and generating a corresponding measure, for the generative model, by comparing the corresponding output to the ground truth response. For example, the value for a first LLM can be based on first score(s) that are each generated based on comparing the ground truth response to first LLM output, for the first LLM, generated based on processing the request using the first LLM. Likewise, the value for a second LLM can be based on second score(s) that are each generated based on comparing the ground truth response to second LLM output, for the second LLM, generated based on processing the request using the second LLM. The score(s) generated based on comparing the ground truth response to given LLM output can be generated based on how closely the given LLM output conforms to the ground truth response. For instance, the score(s) can include a negative log-likelihood score and/or a perplexity score. Those and/or other score(s) can optionally be generated based on comparing the ground truth response to a given sequence of probability distributions over a vocabulary that is reflected in the given LLM output (e.g., generated as a function of the probabilities for the ground truth response in the probability distributions).

The training system 140 can be used to train the EE head 126. The training system 140 is illustrated as including a training engine 142, a measure engine 144, a ground truth (GT) label engine 146, and a training instance engine 148.

The training instance engine 148 can work in cooperation with the measure engine 144 and the GT label engine 146 in generating training instances that each include (a) training instance input that includes at least a request, and (b) ground truth classification labels that are each for a corresponding one of the candidate generative models 150. The training engine 142 can then utilize the training instances, generated by the training instance engine 148, in training the EE head 126 (e.g., in supervised fine-tuning thereof).

In generating a training instance, the training instance engine 148 can identify, from requests, responses database 154, a request and a ground truth response for the request. For example, the ground truth response for the request can be one that was formulated by a human and/or that was verified by human rater(s) as being an appropriate response to the request. The measure engine 144 can, for each of the generative models 150, process the identified request using the generative model to generate corresponding output. For example, the measure engine 144 can process the request using initial generative model 125 to generate first generative output, process the request using GM 150A to generate second generative output, process the request using GM 150B to generate third generative output, etc. Further, the measure engine 144 can, for each of the generative models, generate a measure for the generative model based on the corresponding output. For example, the measure engine 144 can generate the measure based on processing the corresponding generative output using a reward model and/or based on comparing the corresponding generative output to the ground truth response for the request. For example, the measure engine 144 can generate a first measure for the initial generative model 125 based on comparing the first generative output to the ground truth responses, generate a second measure for the GM 150A based on comparing the second generative output to the ground truth response, etc. As another example, the measure engine 144 can generate a first measure for the initial generative model 125 based on processing the first generative output using a reward model, generate a second measure for the GM 150A based on processing the second generative output using the reward model, etc.

Further, the GT label engine 146 can generate ground truth classification labels, for the training instance, as a function of all of the measures generated by the measure engine 144. For example, the GT label engine 146 can generate soft ground truth classification labels that are based on a normalization of all of the measures or can generate hard ground truth classification labels based on all of the measures.

The training instance engine 148 can then generate a training instance that includes, as training instance input, the request and that includes, as training instance output, the ground truth classification labels generated by the GT label engine 146. As referenced above, the training engine 142 can train the EE head 126 based on such a generated training instance, as well as many additional (e.g., thousands, hundreds of thousands) similarly generated training instances.

The training system 140 can optionally also utilize training instances from the training database 153 in training the initial generative model 125 and the EE head 126 in conjunction with training of the initial generative model 125. For example, the training database 153 can include training instances that include training instance input of a corresponding request and training instance output that reflects a corresponding ground truth generative output. The training engine 142 can utilize such training instances to train the initial generative model 125 and the EE head 126. For example, the training engine 142 can fully process training instance input of a training instance, using the initial generative model 125, to generate a predicted generative output and can generate a loss based on comparing the predicted generative output and the ground truth generative output of the training instance. The training engine 142 can adjust weights of the initial generative model 125 and of the EE head 126 based on the loss. For example, the training engine 142 can backpropagate the loss across the initial generative model 125, including the EE head 126. As another example, the training database 153 can include training instances that include training instance input of a corresponding request but that lack ground truth responses. The training engine 142 can utilize such training instances to train the initial generative model 125 and the EE head 126. For example, the training engine 142 can fully process training instance input of a training instance, to generate corresponding output, process the corresponding output using a reward model to generate a reward, and adjust weights of the initial generative model 125 and of the EE head 126 based on the reward (e.g., backpropagate a loss that is based on the reward across the initial generative model 125, including the EE head 126).

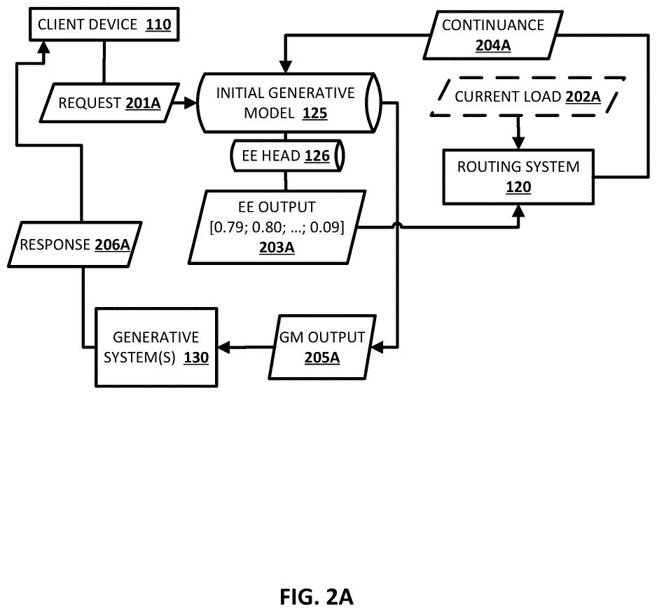

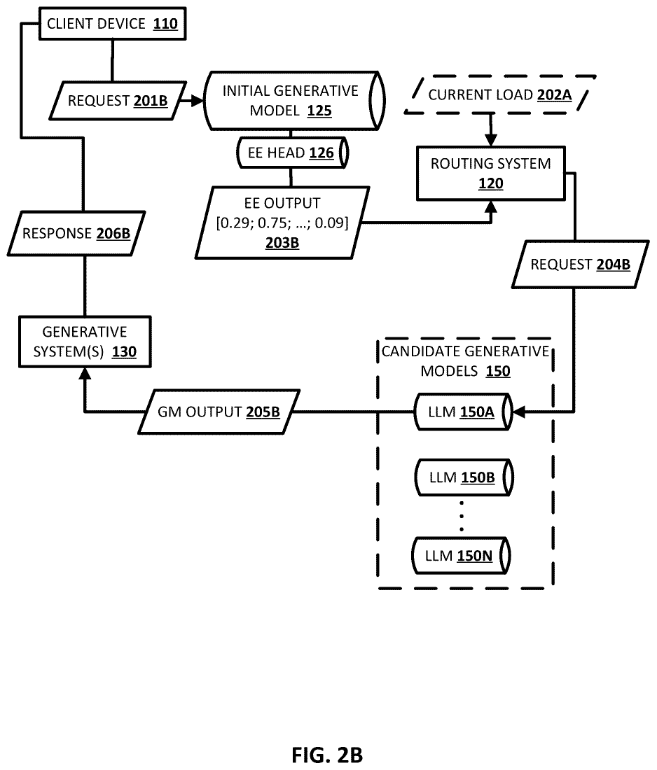

Turning now to FIG. 2A, an example is provided of how components of FIG. 1 can interact in beginning to process a request utilizing the initial generative model 125 and determining to continue, based on output from the EE head 126, utilizing the initial generative model 125 instead of routing the request to any alternative generative model 150. In FIG. 2A, a request 201A is received from client device 110 and processing of the request 201A, utilizing the initial generative model 125, is initiated. During such processing, but prior to completion of such processing, the EE head 126 is utilized to process intermediate layer output and generate EE output 203A. The EE output 203A reflects whether the processing, using the initial generative model 125, should continue, or instead should be routed to one of the alternative generative models 150. For example, as illustrated in FIG. 2A, the EE output 203A includes a continuance measure of 0.79, a second measure of 0.80 that reflects a value for instead utilizing alternative generative model 150A, and an nth measure of 0.09 that reflects a value for instead utilizing alternative generative model 150N. The routing engine 127 can utilize the EE output 203A and determine to provide a continuance indication 204A, that causes continuation of processing of the request utilizing the initial generative model 125. Through such continued processing of the request 201A, GM output 205A is generated as final output. For example, the GM output 205A can include a sequence of probability distributions over a vocabulary that is reflected in the sequence of GM output 205A. The GM output 205A can be provided to one or more of the generative system(s) 130 and the generative system(s) 130 can process the GM output 205A in generating a response 206A to the request 201A. For example, the generative system(s) 130A can decode the GM output 205A in generating the response 206A. The response 206A is provided to the client device 110 responsive to the request 201A.

In determining to provide the continuance indication 204A, the routing engine 127 can utilize one or more of the measures included in the EE output 203A from the EE head 126. For example, the routing engine 127 can utilize the continuance measure (0.79) from the EE output 203A to determine to continue processing of the request 201A utilizing the initial generative model 125. For instance, the routing engine 127 can compare the continuance measure to a threshold (e.g., 0.75) and can determine to continue processing of the request 201A in response to determining that the continuance measure satisfies the threshold and, optionally, without regard to other measure(s) of the EE output 203A. In some implementations, the routing engine 127 determines the threshold based on current load data 202A that reflects a current server load of the routing system 120 and/or one or more of the generative system(s) 130. In some other implementations, the threshold is static. In some implementations or situations the routing engine 127 further utilizes other measure(s) from the EE output 203A in determining to continue processing of the request 201A utilizing the initial generative model 125. For example, the routing engine 127 can determine to continue processing of the request 201A utilizing the initial generative model 125 further based on the other measures that reflect corresponding values for utilizing corresponding of the alternative generative models 150. For instance, the routing engine 127 can determine to continue processing of the request 201A utilizing the initial generative model 125 based on the continuance measure satisfying a threshold and based on the other measure(s) failing to satisfy corresponding threshold(s), such as higher absolute threshold(s) and/or failing to be a threshold value (e.g., 0.15) greater than the continuance measure.

Turning now to FIG. 2B, an example is provided of how components of FIG. 1 can interact in beginning to process a request utilizing the initial generative model 125 and determining, during the processing but prior to completion of the processing, to initiate processing of the request utilizing an alternative generative model 150A. In FIG. 2B, a request 201B is received from client device 110 and processing of the request 201B, utilizing the initial generative model 125, is initiated. During such processing, but prior to completion of such processing, the EE head 126 is utilized to process intermediate layer output and generate EE output 203B. The EE output 203B reflects whether the processing, using the initial generative model 125, should continue, or instead should be routed to alternative generative model 150B. For example, as illustrated in FIG. 2B, the EE output 203B includes a continuance measure of 0.29, a second measure of 0.75 that reflects a value for instead utilizing the alternative generative model 150A, and an nth measure of 0.05 that reflects a value for instead utilizing an alternative generative model 150N. The routing engine 127 can utilize the EE output 203B and determine to provide, at 204B, a routing indication that causes routing of the request 201B to alternative generative model 150A. The routing of the request 201B to the alternative generative model 150A causes the alternative generative model 150A to be used to process the request 201B and generate GM output 205B. The GM output 205B can be provided to the generative system(s) 130 and the generative system(s) 130 can process the GM output 205B in generating a response 206B to the request 201B. For example, the generative system(s) 130 can decode the GM output 205B in generating the response 206B. The response 206B is provided to the client device 110 responsive to the request 201B.

In determining to provide the routing indication 204B, the routing engine 127 can utilize one or more of the measures included in the EE output 203B from the EE head 126. For example, the routing engine 127 can determine to not continue processing of the request 201B utilizing the initial generative model 125 responsive to determining that the continuance measure of 0.29 fails to satisfy a threshold (e.g., 0.75). Further, the routing engine 127 can determine to provide the routing indication 204B, responsive to determining that the continuance measure of 0.29 fails to satisfy the threshold and responsive to determining that the second measure of 0.75 (reflecting a value for instead utilizing alternative generative model 150A) satisfies the threshold or an alternative threshold. For instance, when the continuance measure fails to satisfy the threshold and multiple alternative generative models are available, the routing engine 127 can select, from among the alternative generative models, the alternative generative model that, among those having a corresponding measure satisfying an alternative threshold, is most computationally efficient.

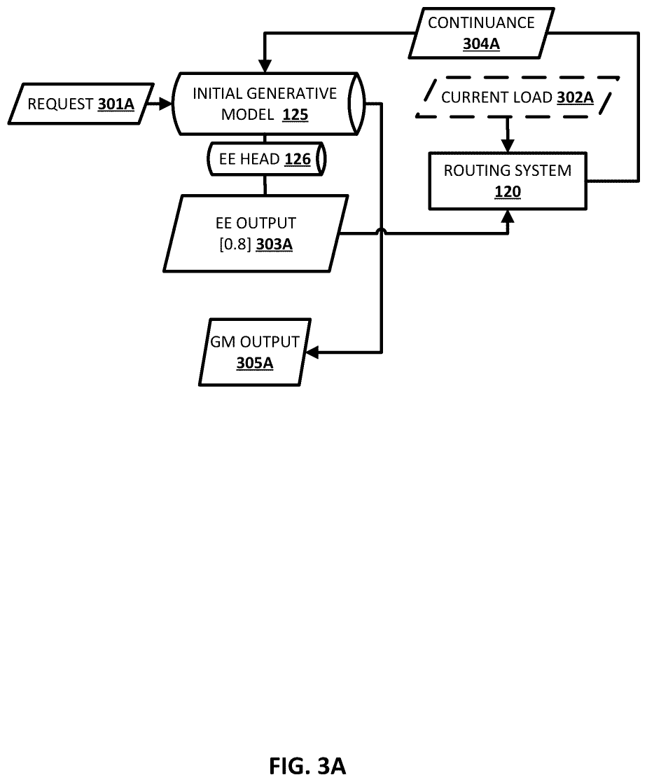

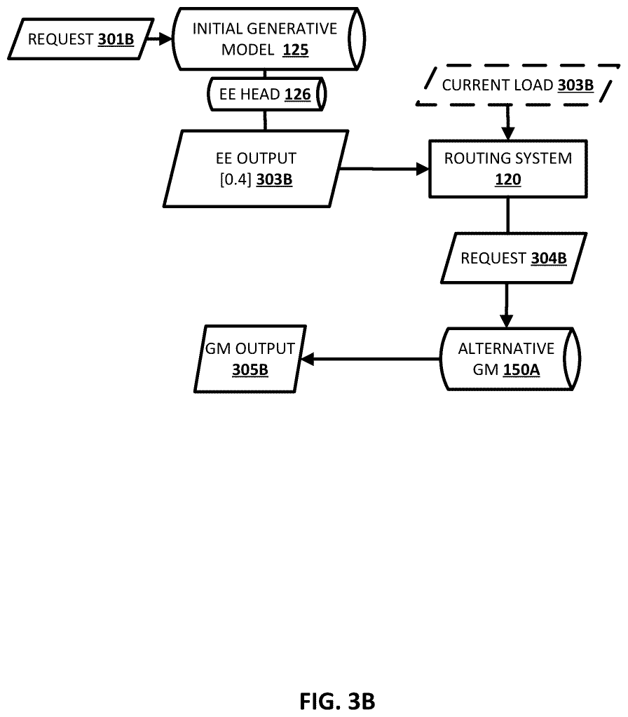

Turning now to FIG. 3A, another example is provided of how components of FIG. 1 can interact in beginning to process a request utilizing the initial generative model 125 and determining to continue, based on output from the EE head 126, utilizing the initial generative model 125 instead of routing the request to any alternative generative model 150. In FIG. 3A, a request 301A is received. For example, the request 301A can be received from a client device or from a server device. Responsive to receiving the request 301A, processing of the request 301A, utilizing the initial generative model 125, is initiated. During such processing, but prior to completion of such processing, the EE head 126 is utilized to process intermediate layer output and generate EE output 303A. The EE output 303A reflects a continuance measure that indicates whether the processing, using the initial generative model 125, should continue, or instead the request 301A should be routed to alternative generative model 150A. For example, as illustrated in FIG. 3A, the EE output 303A includes a continuance measure of 0.8. The routing engine 127 can utilize the EE output 303A and determine to provide a continuance indication 304A, that causes continuation of processing of the request utilizing the initial generative model 125. For instance, the routing engine 127 can compare the continuance measure to a threshold (e.g., 0.75) and can determine to continue processing of the request 301A in response to determining that the continuance measure satisfies the threshold. In some implementations, the routing engine 127 determines the threshold based on current load data 302A that reflects a current server load of the routing system 120 and/or one or more of the generative system(s) 130. In some other implementations, the threshold is static. In response to providing the continuance indication 304A, the initial generative model 125 is utilized to continue processing of the request 301A to generate GM output 305A. The GM output 305A can be provided to one or more system(s) responsive to the request 301A. For example, the GM output 305A can be provided to the device via which the request 301A was received and/or to one or more separate device(s).

Turning now to FIG. 3B, another example is provided of how components of FIG. 1 can interact in beginning to process a request utilizing the initial generative model 125 and determining, during the processing but prior to completion of the processing, to initiate processing of the request utilizing an alternative generative model 150A. In FIG. 3B, a request 301B is received. For example, the request 301B can be received from a client device or from a server device. Responsive to receiving the request 301B, processing of the request 301B, utilizing the initial generative model 125, is initiated. During such processing, but prior to completion of such processing, the EE head 126 is utilized to process intermediate layer output and generate EE output 303B. The EE output 303B reflects a continuance measure that indicates whether the processing, using the initial generative model 125, should continue, or instead the request 301B should be routed to alternative generative model 150A. For example, as illustrated in FIG. 3B, the EE output 303B includes a continuance measure of 0.4. The routing engine 127 can utilize the EE output 303B and determine to provide, via 304B, a routing indication that causes routing of the request 301B to alternative generative model 150A. The routing of the request 301B to the alternative generative model 150A causes the alternative generative model 150A to be used to process the request 301B and generate GM output 305B. The GM output 305B can be provided to one or more system(s) responsive to the request 301B. For example, the GM output 305B can be provided to the device via which the request 301B was received and/or to one or more separate device(s).

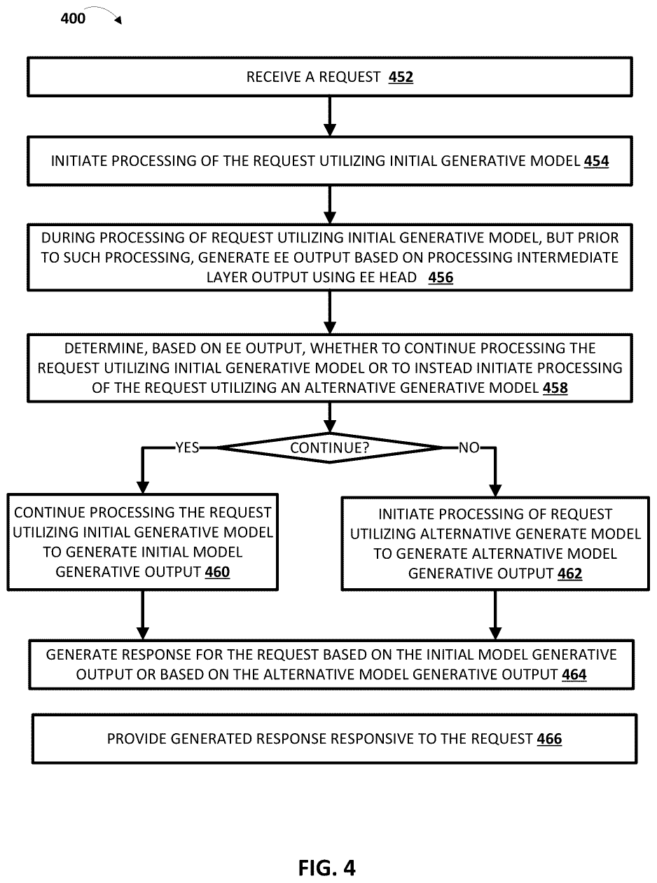

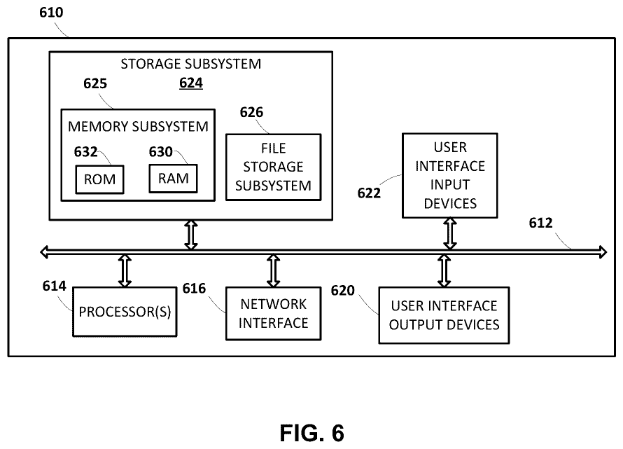

Turning now to FIG. 4, a flowchart is depicted that illustrates an example method 400 of, in response to receiving a request, beginning processing of the request using an initial generative model and, prior to completion of decoding of the request that is based on the initial generative model, determining whether to route the request to an alternative generative model for generating a response to the request or to instead continue using the initial generative model in generating a response to the request. For convenience, the operations of the method 400 are described with reference to a system that performs the operations. This system of the method 400 includes one or more processors, memory, and/or other component(s) of computing device(s) (e.g., client device 110 of FIG. 1, client device 610 of FIG. 6, one or more servers, and/or other computing devices). Moreover, while operations of the method 400 are shown in a particular order, this is not meant to be limiting. One or more operations may be reordered, omitted, and/or added.

At block 452, the system can receive a request. In some implementations, the request is received from a client device. In some of those implementations, the client device is associated with a user and the request is generated based on user input provided by the user. In some implementations, the request is received from a device that is not a client device, such as a request that is received from a server device and that can optionally not be based on user input.

At block 454, the system can, in response to receiving the request, initiate processing of the request utilizing an initial generative model of a set of generative models. In some implementations, the initial generative model is a most computationally efficient generative model of the set of generative models. In some implementations, the initial generative model is provided on a client device via which the request of block 452 is received.

At block 456, the system can, during the processing of the request utilizing the initial generative model, but prior to completing processing of the request utilizing the initial generative model and prior to initiating processing of the request utilizing any additional generative model of the set of generative models, process, using an EE head of the initial generative model intermediate layer output that is generated during the processing of the request. The intermediate layer output is generated utilizing an intermediate layer of the initial generative model. For example, the intermediate layer output can be from an intermediate layer that is a transformer layer of an encoder or decoder of the initial generative model. At block 456, the system generates EE output based on the processing of the intermediate layer output. The EE output reflects whether to continue utilizing the initial generative model or to instead initiate processing of the request utilizing an alternative generative model. For example, the EE output can include a first measure that reflects a value for continuing utilizing the initial generative model and can include one or more other measures that each reflect a corresponding value for a corresponding one of one or more alternative generative models of the set of generative models.

At block 458, the system can determine, based on the EE output of block 456, whether to continue utilizing the initial generative model or to instead initiate processing of the request utilizing an alternative generative model of the set of generative models. For example, assume the EE output includes a first measure and a second measure, where the first measure reflects a value for continuing processing utilizing the initial generative model and the second measure reflects a value for initiating processing utilizing an alternative generative model. In such an example, then block 458 can include determining to continue utilizing the initial generative model based on the first measure and, optionally, based on the second measure. For example, if the first measure satisfies an absolute threshold then block 458 can include determining to continue utilizing the initial generative model without regard to the second measure. As another example, if the first measure is less than the absolute threshold and the second measure is greater than the first measure, and optionally if the second measure is greater than an absolute threshold, then block 403 can include determining to initiate processing of the request utilizing the alternative generative model.

As another example of some implementations of block 458, assume the EE output includes a single measure that reflects a value for continuing processing utilizing the initial generative model. In such an example, then block 403 can include determining to continue utilizing the initial generative model based on the single measure. For example, block 458 can include determining to continue utilizing the initial generative model if the single measure satisfies an absolute threshold then and, otherwise, determining to initiate processing of the request utilizing an alternative generative model.

In some implementations, in selecting a particular generative model from among the candidate alternative generative models, the system further considers a current server load, for the routing system and/or for one or more of the candidate generative models of the set. For example, one or more of the thresholds used to determine the routing decision can be adjusted based on the current server load. For instance, if the server load is high, the thresholds can be adjusted to favor the initial generative model, even if the EE output suggests otherwise. This helps to balance the need for accuracy with the need for efficiency, especially when the server is under heavy load.

At block 460, the system can, in response to determining that the routing decision reflects continuing utilizing the initial generative model, continue processing of the request utilizing the initial generative model to generate initial model generative output. More particularly, the system can continue the processing that was initiated in block 452. In these and other manners, the initial generative model can be utilized to fully process the request without having to route the request to any alternative generative models. Accordingly, latency in responding to the request can be minimized while accuracy of the response can be ensured through utilization of the routing decision that is based on the EE output of block 454.

At block 462, the system can, in response to determining that the routing decision reflects initiating processing of the request utilizing an alternative generative model, initiate processing of the request utilizing the alternative generative model to generate alternative model generative output. At block 462 the system can also cause the processing of the request utilizing the initial generative model, of block 452, to be halted. In these and other manners, further processing of the request by the initial generative model is not performed, thereby conserving computational resources.

At block 464, the system can generate a response for the request based on the initial model generative output, or the alternative model generative output. More particularly, if block 460 was performed, then the response is generated based on the initial model generative output but, if block 462 is performed, then the response is generated based on the alternative model generative output.

At block 466, the system can provide, in response to the request, the generated response.

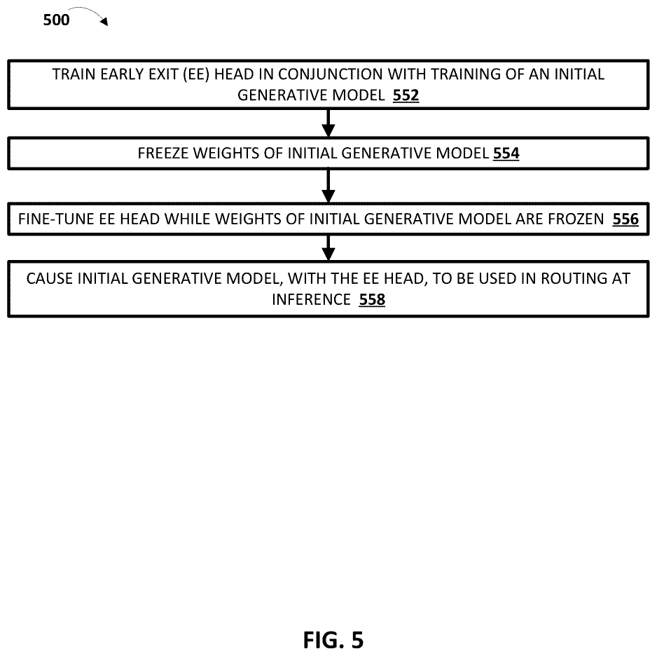

Turning now to FIG. 5, a flowchart is depicted that illustrates an example method 500 of training an early exit (EE) head. For convenience, the operations of the method 500 are described with reference to a system that performs the operations. This system of the method 500 includes one or more processors, memory, and/or other component(s) of computing device(s) (e.g., client device 110 of FIG. 1, client device 610 of FIG. 6, one or more servers, and/or other computing devices). Moreover, while operations of the method 500 are shown in a particular order, this is not meant to be limiting. One or more operations may be reordered, omitted, and/or added.

At block 552, the system trains an early exit (EE) head in conjunction with training of an initial generative model. The EE head is configured to be utilized in processing intermediate layer output, generated using an intermediate layer of the initial generative model, in generating EE output. The intermediate layer is a non-initial layer of the initial generative model and is a non-final layer of the initial generative model. For example, the intermediate layer output can be from an intermediate layer that is a transformer layer of an encoder or decoder of the initial generative model.

In some implementations, in training the EE head in conjunction with training the initial generative model, the system generates losses based on predicted outputs generated using the initial generative model and updates the initial generative model and the EE the head based on such losses. For example, a loss for a predicted output can be generated based on a reward, such as reward generated based on processing the predicted output using a reward model. As another example, a loss for a predicted output can be generated based on comparing the predicted output to ground truth output. In some of those implementations, the system backpropagates a determined loss over the initial generative model and over the EE head. In some other of those implementations, the system backpropagates the loss over the initial generative model and determines a separate loss for updating the EE head. For example, the separate loss for updating the EE head can be based on comparing the EE output to the loss for the predicted output.

As a non-limiting example of block 552, the EE head can be configured to generate EE output that reflects a continuance measure that indicates whether to continue utilizing the initial generative model or to instead route the request to an alternative generative model. A loss for a predicted output (from processing a request fully utilizing the initial generative model) can be generated based on a reward, such as reward generated based on processing the predicted output using a reward model, and/or can be generated based on comparing the predicted output to ground truth output. The system can backpropagate the loss for the predicted output over the initial generative model, but not the EE head. The system can further generate a separate loss for the EE head. For example, the separate loss can be generated based on comparing the EE output to the reward (e.g., to update to an extent that is based on how closely the EE output reflects the reward). For instance, assume the EE output is from 0 to 1, with 1 being most indicative of continuance and assume that the reward is from 0 to 1, with 1 being indicative of the highest reward. In such an instance, a greater delta between the EE output and the reward can result in a greater loss than does a lesser delta between the EE output and the reward. This can train the EE head to generate EE output to approximate the reward that would be generated by a reward model-but to do so based on processing intermediate output as opposed to final predicted output. As another example, the separate loss can additionally or alternatively be based on comparing the EE output to the predicted probability, for the ground truth output, in the predicted output (e.g., to update to an extent that is based on how closely the EE output reflects the probability of the ground truth output). For instance, assume the EE output is from 0 to 1, with 1 being most indicative of continuance and assume that the predicted probability, for the ground truth output, in the predicted output, is 0.62. In such an instance, the separate loss can be based on the difference between the EE output and the predicted probability, for the ground truth output, in the predicted output. This can train the EE head to generate EE output to approximate the probability that would be reflected, in final predicted output of the initial generative model, for correct output-but to do so based on processing intermediate output.

At block 554, the system freezes weights of the initial generative model following completion of training of the initial generative model. Put another way, after training of the initial generative model is completed, the weights of the initial generative model are frozen. However, the weights of the EE head are not frozen and will be further adjusted during the fine-tuning of the EE head at block 556.

At block 556, the system fine-tunes the EE head while the weights of the initial generative model are frozen. For example, the system can further train the EE head using supervised training instances and/or using techniques described above with respect to block 552, but without any updating of the initial generative model. For instance, supervised training instances can be used that each include a corresponding request and corresponding ground truth EE output. The request of a supervised training instance can be initially processed, using the frozen initial generative model, to generate intermediate layer output and that intermediate layer output can be processed, using the EE head, to generate EE output. A loss can be generated based on comparing the ground truth EE output to the generated EE output, and used to update the EE head (without any further updating of the initial generative model). Also, for instance, non-supervised training instances can be used that each include a corresponding request. The request can be processed, using the frozen initial generative model, to generate intermediate layer output and that intermediate layer output can be processed, using the EE head, to generate corresponding EE output. Further, processing of the request utilizing the frozen initial generative model can continue to generate corresponding predicted output. Yet further, the predicted output can be processed, using a reward model, to generate a reward. A loss can be generated based on comparing the reward to the EE output, and used to update the EE head (without any further updating of the initial generative model).

At block 558, the system causes the initial generative model, with the EE head, to be used in routing at inference. For example, the system can cause the initial generative model to be utilized in performing iterations of method 400 of FIG. 4. Causing the initial generative model to be used in routing at inference can include providing the initial generative model to device(s) (e.g., client device(s)) and/or providing access to the initial generative model via application programming interface(s) or the like.

Turning now to FIG. 6, a block diagram of an example computing device 610 that may optionally be utilized to perform one or more aspects of techniques described herein is depicted. In some implementations, one or more of a client device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIG. 1.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In various implementations, a method implemented by one or more processors is provided and includes receiving a request. In response to receiving the request, the request can be processed utilizing an initial generative model from a set of generative models. During the processing of the request using the initial generative model, but before completing processing of the request using the initial generative model and before initiating processing of the request using any additional generative model from the set of generative models, intermediate layer output can be generated using an intermediate layer of the initial generative model. This intermediate layer output can then be processed using an early exit (EE) head of the initial generative model to determine a routing decision. A determination can be made as to whether the routing decision reflects continuing to use the initial generative model or initiating processing of the request using an alternative generative model from the set of generative models. In response to determining that the routing decision reflects continuing to use the initial generative model, processing of the request can continue using the initial generative model to generate initial model generative output. In response to determining that the routing decision reflects using the alternative generative model, processing of the request can be caused to be performed using the alternative generative model to generate alternative model generative output. A generated response for the request can be generated based on either the initial model generative output or the alternative model generative output. The response can be generated based on the initial model generative output when the routing decision reflects continuing to use the initial generative model, and the response can be generated based on the alternative model generative output in response to determining that the routing decision reflects using the alternative generative model. Finally, the generated response can be provided in response to the request.

The processing, using the EE head of the initial generative model, of the intermediate layer output to determine the routing decision can include generating, based on processing the intermediate layer output using the EE head, a continuance measure that characterizes values for continuing processing using the initial generative model. The routing decision can then be based on the continuance measure.

In some implementations, the processing, using the EE head of the initial generative model, of the intermediate layer output to determine the routing decision can include generating, based on processing the intermediate layer output using the EE head, a second measure that characterizes a value for utilizing the alternative generative model. The routing decision can be further based on the second measure. In some versions of those implementations, the processing, using the EE head of the initial generative model, of the intermediate layer output to determine the routing decision can include generating, based on processing the intermediate layer output using the EE head, a third measure that characterizes a value for utilizing a third generative model of the set of generative models. The routing decision can be further based on the third measure. In some of those versions, the routing decision can be to continue utilizing the initial generative model. In some of those versions, the routing decision can be based on the continuance measure satisfying a threshold such as a threshold that is absolute or that is relative to the second measure.

In some implementations, the initial generative model can include a lesser quantity of parameters relative to the alternative generative model. In some versions of those implementations, the quantity of parameters of the initial generative model can be at least 25% less than the quantity of parameters of the alternative generative model.

In some implementations, the initial generative model can be quantized relative to the alternative generative model.

In some implementations, the EE head can be trained in conjunction with the initial generative model. In some of those implementations, the weights of the initial generative model can be frozen following completion of training of the initial generative model in conjunction with the EE head. The method can further include, prior to the processing of the request utilizing the alternative generative model: freezing the weights of the initial generative model; and fine-tuning the EE head while the weights of the initial generative model are frozen.

In some implementations, the intermediate layer can be prior to a terminal layer of the initial generative model and/or can be subsequent to an initial layer of the initial generative model. In some versions of those implementations, the intermediate layer can be a decoding layer of the initial generative model. In some of those versions, the initial generative model can be a decoder-only generative model.

In some implementations, the initial generative model can be on a client device. Processing of the request utilizing the initial generative model can be performed on the client device, and the alternative generative model can be remote from the client device.

In some implementations, the processing, using the EE head of the initial generative model, of the intermediate layer output to determine the routing decision can include generating, based on processing the intermediate layer output using the EE head, a continuance measure that characterizes values for continuing processing using the initial generative model. A determination can be made as to whether the continuance measure satisfies a threshold. It can be determined that the routing decision reflects continuing utilizing the generative model when the continuance measure satisfies a threshold and it can be determined that the routing decision reflects utilizing the alternative generative model when the continuance measure fails to satisfy the threshold.

In some implementations, the threshold can be a fixed threshold or a dynamic threshold based on a current server load. The current server load can characterize a magnitude of computational resource utilization being experienced by one or more servers associated with the initial generative model and/or the alternative generative model.

In some implementations, the processing, using the EE head of the initial generative model, of the intermediate layer output to determine the routing decision can include utilizing a current server load in determining the routing decision. In some of those implementations, utilizing the current server load in determining the routing decision can include determining a threshold based on the current server load, and determining the routing decision based on the threshold.

In various implementations, a method implemented by one or more processors is provided and includes training an early exit (EE) head in conjunction with the training of an initial generative model. The early exit head can be used in processing intermediate layer output, generated using an intermediate layer of the initial generative model, to generate one or more measures that reflect a routing decision. The weights of the initial generative model can be frozen following the completion of training of the initial generative model. The EE head can then be fine-tuned while the weights of the initial generative model are frozen. After the EE head is fine-tuned, the initial generative model, with the EE head, can be used in routing during inference.

In some implementations, the intermediate layer can be before a terminal layer of the initial generative model and/or after an initial layer of the initial generative model.

In some implementations, the one or more measures that can reflect the routing decision can include a continuance measure that can characterize a value for continuing processing using the initial generative model. In some versions of those implementations, the one or more measures that can reflect the routing decision can include a second measure that can characterize a value for utilizing an alternative generative model. In some of those versions, the one or more measures that can reflect the routing decision can include a third measure that can characterize a value for utilizing a third generative model.

What is claimed is:

1. A method implemented by one or more processors, the method comprising:
receiving a request;
in response to receiving the request: processing the request utilizing an initial generative model of a set of generative models;
during the processing of the request utilizing the initial generative model, but prior to completing processing of the request utilizing the initial generative model and prior to initiating processing of the request utilizing any additional generative model of the set of generative models:
generating intermediate layer output, utilizing an intermediate layer of the initial generative model;
processing, using an early exit (EE) head of the initial generative model, the intermediate layer output to determine a routing decision;
determining whether the routing decision reflects continuing utilizing the initial generative model or initiating processing of the request utilizing an alternative generative model of the set of generative models;
in response to determining that the routing decision reflects continuing utilizing the initial generative model, continuing processing of the request utilizing the initial generative model to generate initial model generative output;
in response to determining that the routing decision reflects utilizing the alternative generative model: causing processing of the request utilizing the alternative generative model to generate alternative model generation output; and
generating a generated response for the request based on: the initial model generative output, or the alternative model generative output, wherein the response is generated based on the initial model generative output when the routing decision reflects continuing utilizing the initial generative model and the response is generated based on the alternative model generation output in response to determining that the routing decision reflects utilizing the alternative generative model; and providing, in response to the request, the generated response.

2. The method of claim 1, wherein processing, using the EE head of the initial generative model, the intermediate layer output to determine the routing decision includes:
generating, based on processing the intermediate layer output using the EE head, a continuance measure that characterizes a values for continuing processing using the initial generative model; and determining the routing decision based on the continuance measure.

3. The method of claim 2, wherein processing, using the EE head of the initial generative model, the intermediate layer output to determine the routing decision includes:
generating, based on processing the intermediate layer output using the EE head, a second measure that characterizes a value for utilizing the alternative generative model; and determining the routing decision further based on the second measure.

4. The method of claim 3, wherein processing, using the EE head of the initial generative model, the intermediate layer output to determine the routing decision includes:
generating, based on processing the intermediate layer output using the EE head, a third measure that characterizes a value for utilizing a third generative model of the set of generative models; and determining the routing decision further based on the third measure.

5. The method of claim 4, wherein the routing decision is to continue utilizing the initial generative model.

6. The method of claim 5, wherein the routing decision is based on the continuance measure satisfying a threshold.

7. The method of claim 6, wherein the threshold is absolute or is relative to the second measure.

8. The method of claim 1, wherein the initial generative model includes a lesser quantity of parameters relative to the alternative generative model.

9. The method of claim 8, wherein the quantity of parameters of the initial generative model is at least 25% less than the quantity of parameters of the alternative generative model.

10. The method of claim 1, wherein the initial generative model is quantized relative to the alternative generative model.

11. The method of claim 1, wherein the EE head is trained in conjunction with the initial generative model.

12. The method of claim 11, wherein weights of the initial generative model are frozen following completion of training of the initial generative model in conjunction with the EE head and further comprising, prior to the processing of the request utilizing the alternative generative model: freezing the weights of the initial generative model; and fine-tuning the EE head while the weights of the initial generative model are frozen.

13. The method of claim 1, wherein the intermediate layer is prior to a terminal layer of the initial generative model.

14. The method of claim 13, wherein the intermediate layer is subsequent to an initial layer of the initial generative model.

15. The method of claim 14, wherein the intermediate layer is a decoding layer of the initial generative model.

16. The method of claim 15, wherein the initial generative model is a decoder only generative model.

17. The method of claim 1, wherein the initial generative model is on a client device, wherein processing of the request utilizing the initial generative model is performed on the client device, and wherein the alternative generative model is remote from the client device.

18. The method of claim 1, wherein the processing, using the EE head of the initial generative model, the intermediate layer output to determine the routing decision includes:
generating, based on processing the intermediate layer output using the EE head, a continuance measure that characterizes a values for continuing processing using the initial generative model;
determining whether the continuance measure satisfies a threshold; and
determining that the routing decision reflects continuing utilizing the generative model when the continuance measure satisfies a threshold and determining that the routing decision reflects utilizing the alternative generative model when the continuance measure fails to satisfy the threshold.

19. The method of claim 18, wherein the threshold is a fixed threshold or is a dynamic threshold that is based on a current server load, the current server load characterizing a magnitude of computational resource utilization being experienced by one or more servers associated with the initial generative model and/or the alternative generative model.

20. The method of claim 1, wherein processing, using the EE head of the initial generative model, the intermediate layer output to determine the routing decision, further comprises: utilizing a current server load in determining the routing decision.

21. The method of claim 20, wherein utilizing the current server load in determining the routing decision includes: determining a threshold based on the current server load; and determining the routing decision based on the threshold.

22. A method implemented by one or more processors, the method comprising:
training an early exit (EE) head in conjunction with training of an initial generative model, the early exit head being utilized in processing intermediate layer output, generated utilizing an intermediate layer of the initial generative model, to generate one or more measures that reflect a routing decision;
freezing weights of the initial generative model following completion of training of the initial generative model;
fine-tuning the EE head while the weights of the initial generative model are frozen; and
after fine-tuning the EE heard:
utilizing the initial generative model, with the EE head in routing at inference.
